(19) United States
(12) Patent Application Publication
(10) Pub. No.: US 2026/0029315 A1
(43) Pub. Date: Jan. 29, 2026

(54) SAMPLE PREPARATION DEVICE

(71) Applicant: Endress+Hauser Conducta GmbH+Co. KG, Gerlingen (DE)

(72) Inventors: Hui Huang, Suzhou 215000 (CN); Wenbin Zhang, Suzhou (CN)

(21) Appl. No.: 19/278,135

(22) Filed: Jul. 23, 2025

(30) Foreign Application Priority Data
Jul. 23, 2024 (CN) 202410989750.X

(51) Int. Cl. G01N 1/34; B01L 3/00

(52) U.S. Cl. CPC G01N 1/34; B01L 3/502753; B01L 2300/0681; B01L 2400/0481

(57) ABSTRACT

A sample preparation device for analyzing a liquid sample, the sample preparation device including a container and a stirrer. The stirrer includes a motor, a stirring rod, and blades for stirring a sample within a mixing chamber of the container and pulverizing particles in the sample. The motor drives the stirring rod and/or the blades to rotate, and the motor has an adjustable speed. The motor, the stirring rod, and/or the blades are movable in a vertical direction. The container has an inlet for supplying the sample and at least one first outlet for discharging the sample, wherein a filter device is provided at the first outlet.

### CROSS-REFERENCE TO RELATED APPLICATION

The present application is related to and claims the priority benefit of Chinese Patent Application No. 202410989750.X, filed on Jul. 23, 2024, the entire contents of which are incorporated herein by reference.

### TECHNICAL FIELD

The present disclosure relates to a sample preparation device for analyzing a liquid sample, a method for preparing a liquid sample, and a system for analyzing a liquid sample.

### BACKGROUND

Analysis of a liquid includes measuring and evaluating various characteristics of the liquid to ensure efficient process management. In the field of liquid analysis, in many cases, liquid samples to be analyzed contain particles, and the samples may be water or wastewater. Excessive particles in a sample clog pipes inside of a liquid analysis device, which obstructs normal flow of the sample within the system. If the sample is not sufficiently stirred, the particles therein precipitate to form a precipitate. Poor homogenization caused by precipitates affects the repeatability and accuracy of measurement by an analysis device. In addition, these particles may contain specific chemical factors to be detected and measured. Simply filtering out all the particles may result in reduced measurement values.

A common stirrer in laboratories is a magnetic stirrer, which is a laboratory device that stirs liquids by means of a rapidly rotating stirring bar. The magnetic stirrer consists of a magnetic bar/stirring bar placed in a liquid, the magnetic bar providing a stirring action. The movement of the stirring bar is driven by another rotating magnet or electromagnet assembly in the stirrer device, and the magnet or electromagnet assembly is located below a container containing the liquid.

U.S. Pat. No. 2,350,534A discloses a magnetic stirrer, wherein the stirrer is represented by an element that is freely movable and preferably not connected, but responds to magnetic forces.

A homogenizer is a laboratory or industrial stirrer used to pulverize or homogenize various materials such as tissues, plants, foods, soil, etc. Many different destruction models have been developed using various physical techniques. The most common homogenizers may be mortars and pestles, which have been used for thousands of years, and are a standard tool even in modern laboratories. More modern solutions are based on stirrers having a motor and a stirring rod. The prior art includes the PRO D-Series® homogenizer series from PRO Scientific Inc.

The homogenizer is similar to the magnetic stirrer, and its function is only to simply pulverize or stir a sample in a container, and cannot filter particles inside the sample. In addition, the particles inside the sample cannot be well pulverized, and the particle size of the particles cannot be reduced any more after being reduced to a certain extent in most cases. In addition, the stirring rod rotating at a high speed generates a vortex, which causes part of the liquid level of the sample to rise, and sometimes causes the sample to overflow from the container.

Therefore, new methods are needed for preparing samples so that the process of liquid analysis is more reliable and efficient.

### SUMMARY

Therefore, an object of the present disclosure is to provide a sample preparation device for analyzing a liquid sample, a method for preparing a liquid sample, and a system for analyzing a liquid sample, which can both pulverize particles in the sample well and continuously stir the sample, and make the size of the particles in the sample entering a liquid analysis device within a range that can be safely processed by the liquid analysis device.

According to the disclosure, the sample preparation device comprises a container and a stirrer, wherein the stirrer comprises a motor, a stirring rod, and blades for stirring a sample within a mixing chamber of the container and pulverizing particles in the sample. The motor drives the stirring rod and/or the blades to rotate, and the motor has an adjustable speed. The motor, the stirring rod, and/or the blades are movable in a vertical direction, wherein the container has an inlet for supplying the sample and at least one first outlet for discharging the sample. Since a filter device is provided at the first outlet, larger particles cannot enter a liquid analysis device through the filter device, making safe processing of the sample possible.

The present disclosure relates to a sample preparation device for analyzing a liquid sample. The present disclosure further relates to a method for preparing a liquid sample and a system for analyzing a liquid sample.

### BRIEF DESCRIPTION OF THE DRAWINGS

The present disclosure will be further described below with reference to the accompanying drawings and specific embodiments.

FIG. 1 is a schematic diagram of an embodiment of the present disclosure;

FIG. 2 is a side view of the embodiment in FIG. 1;

FIG. 3 is an enlarged view of portion A in FIG. 2;

FIG. 4 is a top view of the embodiment in FIG. 1;

FIG. 5 is an enlarged view of FIG. 4;

FIG. 6 is another enlarged view of FIG. 4; and

FIG. 7 is another side view of the embodiment in FIG. 1.

### DETAILED DESCRIPTION

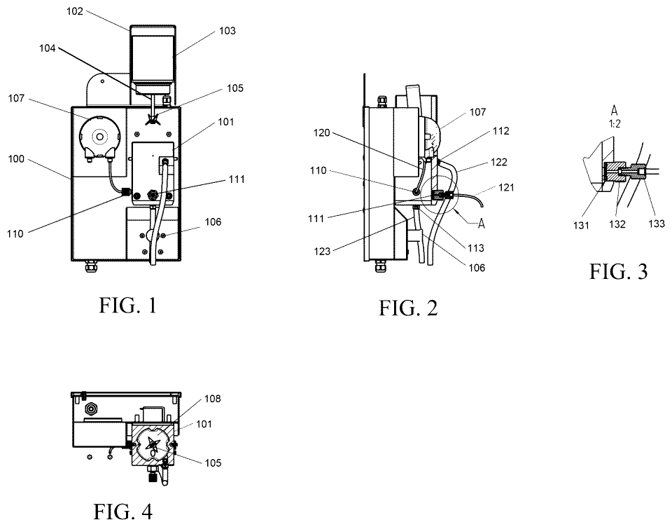

FIG. 1 illustrates an embodiment of the present disclosure including a sample preparation device 100 for analyzing a liquid sample, a container 101 for containing the sample and processing the sample, and a stirrer 102 for stirring the sample and pulverizing particles in the sample.

Processing the sample refers to stirring the sample and/or pulverizing the particles in the sample.

The container 101 is provided with an inlet 110 for supplying a sample and at least one first outlet 111 for discharging the sample. In addition, the container 101 is provided with a mixing chamber (not shown) for containing the sample and processing the sample.

The stirrer 102 includes a motor 103, a stirring rod 104, and blades 105 at one end of the stirring rod 104. The other end of the stirring rod 104 is connected to the motor 103, and the motor 103 drives the stirring rod 104 and/or the blades 105 to rotate. In some embodiments, the stirring rod 104 does not rotate with the motor 103. In this case, a transmission device inside the stirring rod 104 may drive the blades 105 located at the one end of the stirring rod 104 to rotate. The blade 105 may be a reverse blade or any blade having good pulverizing and stirring functions. The stirrer 102 includes the motor 103, the stirring rod 104, and the blades 105, all or part of which are separately movable at least in a vertical direction, to facilitate adjustment of positions of the blades 105 when processing the sample. When processing the sample, the blades 105 should be kept in sufficient contact with the sample, and if necessary, the blades 105 should be immersed below the liquid level of the sample, so as to sufficiently stir the sample and pulverize the particles in the sample. In some embodiments, the stirring rod 104 may be detached from the stirrer 102 together with the blades 105, which is convenient for cleaning or replacement. In some embodiments, the stirring rod 104 and the motor 103 are integrated, and only the blades 105 are detachable. The speed of the motor 103 is adjustable. In some embodiments, the motor 103 first pulverizes the particles in the sample at a first speed and then stirs the sample at a second speed, wherein the first speed is greater than the second speed. Generally, pulverizing the particles in the sample requires the blades 105 to rotate at a high speed, whereas stirring the sample often only needs to be performed at a low speed. After pulverization, the sample is continuously stirred at a slow speed, so that the particles do not form a precipitate, and the pulverized particles can be conveyed to a liquid analysis device (not shown) through the first outlet 111, thereby improving reliability of analysis.

FIG. 2 illustrates a side view of the embodiment in FIG. 1, including the inlet 110. In some embodiments, the container 101 has a second outlet 112 for automatically discharging excess sample. The position of the second outlet 112 is higher than that of the first outlet 111. In some embodiments, the bottom of the container 101 is provided with a third outlet 113 for completely discharging the sample.

As shown in FIG. 2, the sample may be supplied by means of a peristaltic pump 107 and an input conduit 120, but may also be supplied by other means. The input conduit 120 is in communication with the inlet 110. The container 101 may discharge the sample from the container 101 and then convey it to the liquid analysis device by means of the first outlet 111 and a first output conduit 121. A sample preparation device 100 may be provided with a second output conduit 122, and the second output conduit 122 is in communication with the second outlet 112, so that the excess sample can be discharged from the second outlet 112. The third outlet 113 may be in communication with a third output conduit 123. In addition, a valve 106 must be provided at the third output conduit 123, and the valve 106 may be a pinch valve. The provision of the third outlet 113, the third output conduit 123, and the valve 106 allows the excess sample to be discharged from the container 101.

FIG. 3 is an enlarged view of portion A in FIG. 2, including a filter device 131. The filter device 131 is located at the first outlet 111 (see FIG. 2) and may be a filter membrane. In some embodiments, the filter device 131 is replaceable. A first connecting device 132 and a second connecting device 133 are provided between the filter device 131 and the first output conduit 121, and the filter device 131 and the first output conduit 121 are connected together by means of the first connecting device 132 and the second connecting device 133. Likewise, the first connecting device 132 and the second connecting device 133 are replaceable. The presence of the filter device 131 may ensure that the particles in the sample entering the liquid analysis device are at a size that can be safely processed by the analysis device.

FIG. 4 is a top view of the embodiment in FIG. 1, including the container 101 and the blades 105. The container 101 is provided with a mixing chamber 108 for containing the sample and processing the sample. In some embodiments, the outer profile of the container 101 is a rectangular cuboid, and the mixing chamber 108 therein is cylindrical in shape. As shown in FIG. 7, the mixing chamber 108 is straight and parallel on both sides, forming a shape like a tube or a can, wherein the cross section of this part of the mixing chamber 108 is a circle (see the dashed line in FIG. 6), and the diameter from the mixing chamber top 154 to the mixing chamber bottom 153 remains unchanged.

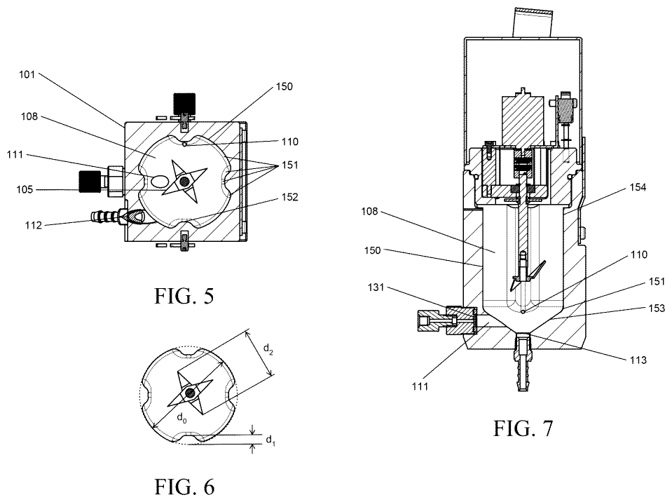

FIG. 5 is an enlarged view of FIG. 4, including the container 101, the blades 105, the mixing chamber 108, the inlet 110, the first outlet 111, the second outlet 112, a mixing chamber wall 150, and a fillet 151. In some embodiments, the sample preparation device 100 is further provided with at least one flow blocking structure 152. The flow blocking structure 152 may prevent the sample from rotating with the blades 105. During the stirring or pulverizing process, the sample in the mixing chamber 108 tends to rotate with the rotating blades 105 due to inertia of the medium. The flow blocking structure 152 has a flow-cutting function, and its presence can effectively prevent the sample pushed by a central blade 105 from rotating in the mixing chamber 108, thereby promoting stirring, pulverizing, and mixing of the sample. The number of flow blocking structures 152 may be two, three, or four. As shown in FIG. 5, four flow blocking structures 152 extend from the bottom to the top of the mixing chamber 108 and are vertically and evenly arranged within the mixing chamber 108. As can be seen, the flow blocking structures 152 are formed by protruding from the mixing chamber wall 150 of the container 101, that is, the flow blocking structures 152 are integrated with the container 101. The fillet 151 is formed at the transition of the mixing chamber wall 150 with the flow blocking structure 152 and the mixing chamber bottom 153 (see FIG. 7). The provision of the fillet 151 may prevent the sample and the particles in the sample from easily adhering to the mixing chamber 108. Certainly, the flow blocking structure 152 may not be integrated with the mixing chamber wall 150, and it may be arranged/fixed on the mixing chamber wall 150. The flow blocking structure 152 may be any cylinder having a flow-cutting function, preferably a cylinder having a fillet 151 or a plate-like cuboid.

The high-speed rotation of the blades 105 will generate a vortex in the mixing chamber 108, causing the free surface of the liquid sample to be in a parabolic shape, wherein the liquid level at the vortex core will be lowered, and the liquid level away from the vortex core will be raised, thereby easily causing the sample to overflow. The presence of the flow blocking structure 152 can block the formation of a vortex at the center of the mixing chamber 108, or reduce the rise of the liquid level caused by the vortex, so that the sample cannot easily overflow. The height of the flow blocking structure 152 has an influence on preventing the sample from rotating with the blades 105 and blocking the liquid level rise of the mixing chamber 108. In some embodiments, the maximum height of the flow blocking structure 152 in the mixing chamber 108 is higher than the height of the entire surface of the sample at rest, in particular the height of the free surface of the sample before processing the sample. In order to achieve a maximum flow-cutting effect, the height of the flow blocking structure 152 may be higher than the height of the entire free surface of the sample when the sample is processed.

In some embodiments, the width d1 of the flow blocking structure 152 is 0.07 to 0.15 times, preferably 0.08 times, the mixing chamber diameter do (see FIG. 6). The maximum diameter d2 of the blades 105 may be 0.3 to 0.6 times, preferably 0.5 times, the mixing chamber diameter do. The mixing chamber diameter do refers to the diameter of the cylindrical portion of the mixing chamber 108.

FIG. 7 is another side view of the embodiment in FIG. 1, including the mixing chamber 108, the inlet 110, the first outlet 111, the third outlet 113, the filter device 131, the mixing chamber wall 150, the mixing chamber bottom 153, and the mixing chamber top 154. As shown in FIG. 7, in some embodiments, the mixing chamber bottom 153 is conical in shape, wherein this portion of the mixing chamber 108 tapers smoothly downward to a point from the mixing chamber top 154 to the mixing chamber bottom 153, forming a shape similar to an ice cream cone. A fillet 151 is formed at the transition between the mixing chamber wall 150 and the mixing chamber bottom 153, which is advantageous for preventing the particles from adhering to the mixing chamber 108. The third outlet 113 may be located at the tip of the cone of the mixing chamber bottom 153, which is advantageous for the discharge of the sample and the particles therein, without adhering to the mixing chamber bottom 153.

1. A sample preparation device for analyzing a liquid sample, the sample preparation device comprising:
a container; and
a stirrer;
wherein the stirrer comprises a motor, a stirring rod, and blades for stirring a sample within a mixing chamber of the container and pulverizing particles in the sample;
wherein the motor drives the stirring rod and/or the blades to rotate;
wherein the motor has an adjustable speed;
wherein the motor, the stirring rod, and/or the blades are movable in a vertical direction;
wherein the container has an inlet for supplying the sample and at least one first outlet for discharging the sample; and
wherein a filter device is provided at the first outlet.

2. The sample preparation device according to claim 1, wherein:
the filter device is replaceable.

3. The sample preparation device according to claim 1, wherein:
the sample preparation device further comprises at least one flow blocking structure, wherein the flow blocking structure prevents the sample from rotating with the blades.

4. The sample preparation device according to claim 3, wherein:
the flow blocking structure extends from a mixing chamber bottom to a mixing chamber top and is vertically arranged within the mixing chamber.

5. The sample preparation device according to claim 4, wherein:
the maximum height of the flow blocking structure within the mixing chamber is higher than the height of the entire free surface of the sample at rest, wherein the height of the entire free surface of the sample at rest is the height of the surface of the sample before processing the sample, and wherein processing the sample refers to stirring the sample and/or pulverizing particles in the sample.

6. The sample preparation device according to claim 5, wherein:
the maximum height of the flow blocking structure within the mixing chamber is higher than the height of the entire free surface of the sample when processing the sample.

7. The sample preparation device according to claim 3, wherein:
a mixing chamber wall of the container protrudes to form the flow blocking structure;
wherein a fillet is formed at a transition between the flow blocking structure and the mixing chamber wall.

8. The sample preparation device according to claim 3, wherein:
the width of the flow blocking structure is 0.07 to 0.15 times a mixing chamber diameter;
wherein the maximum diameter of the blades is 0.3 to 0.6 times the mixing chamber diameter.

9. The sample preparation device according to claim 3, wherein:
there are two to four flow blocking structures, which are evenly arranged along the mixing chamber wall.

10. The sample preparation device according to claim 1, wherein:
the container has a second outlet for automatically discharging excess sample;
wherein the position of the second outlet is higher than that of the first outlet;
wherein the second outlet is in communication with a second output conduit.

11. The sample preparation device according to claim 1, wherein:
a bottom part of the container is provided with a third outlet for completely discharging the sample;
wherein the third outlet is in communication with a third output conduit;
wherein a valve is provided at the third output conduit.

12. The sample preparation device according to claim 1, wherein:
the mixing chamber bottom of the container is conical in shape;
wherein a fillet is formed at a transition between the mixing chamber bottom and the mixing chamber wall.

13. The sample preparation device according to claim 1, wherein
the stirring rod and/or the blades are detachable.

14. The sample preparation device according to claim 1, wherein
the sample preparation device further comprises a peristaltic pump for conveying the sample and an input conduit;
wherein the input conduit is in communication with the inlet.

15. A method for preparing a liquid sample, the method comprising the following steps:
providing a sample preparation device including:
a container; and
a stirrer;
wherein the stirrer comprises a motor, a stirring rod, and blades for stirring a sample within a mixing chamber of the container and pulverizing particles in the sample;
wherein the motor drives the stirring rod and/or the blades to rotate;
wherein the motor has an adjustable speed;
wherein the motor, the stirring rod, and/or the blades are movable in a vertical direction;
wherein the container has an inlet for supplying the sample and at least one first outlet for discharging the sample; and
wherein a filter device is provided at the first outlet;
conveying a sample through the inlet into the container;
ensuring that the blades are in contact with the sample; and
pulverizing the particles in the sample and stirring the sample within the container by using the stirrer.

16. The method according to claim 15, wherein
the stirrer pulverizes the particles in the sample at a first speed, and then continuously stirs the sample at a second speed;
wherein the first speed is greater than the second speed.

17. A system for analyzing a liquid sample, the system comprising:
a sample preparation device including:
a container; and
a stirrer;
wherein the stirrer comprises a motor, a stirring rod, and blades for stirring a sample within a mixing chamber of the container and pulverizing particles in the sample;
wherein the motor drives the stirring rod and/or the blades to rotate;
wherein the motor has an adjustable speed;
wherein the motor, the stirring rod, and/or the blades are movable in a vertical direction;
wherein the container has an inlet for supplying the sample and at least one first outlet for discharging the sample; and
wherein a filter device is provided at the first outlet;
a liquid analysis device; and
a first output conduit connecting the sample preparation device and the liquid analysis device;
wherein the first output conduit is in communication with the first outlet.
